(19) United States
(12) Patent Application Publication
(10) Pub. No.: US 2023/0418558 A1
(43) Pub. Date: Dec. 28, 2023

(54) COMPUTER-BASED VERIFICATION OF MODULAR CORRECTIONS OF MULTIPLE LINEAR OPERATIONS IN PARALLEL

(71) Applicant: International Business Machines Corporation, Armonk, NY (US)

(72) Inventors: Yvo Thomas Bernard Mulder, Reutingen (DE); Michael Johannes Jaspers, Eindhoven (NL); Silvia Melitta Mueller, St. Ingbert (DE); Ulrich Mayer, Weil im Schoenbuch (DE)

(21) Appl. No.: 17/808,631

(22) Filed: Jun. 24, 2022

(51) Int. Cl. G06F 7/523; G06F 21/60

(52) U.S. Cl. CPC G06F 7/523; G06F 21/604

(57) ABSTRACT

Generation of test data for verifying a modular correction of a modular multiplication performed by a multiplier unit for very wide operands includes performing, by a multiplier unit using a computer, a modular multiplication by correcting a binary multiplication of two operands by a coarse-grained and a fine-grained correction. The computer selects adjacent intervals of the intermediate result, defines a sub-interval closely around a boundary between the adjacent intervals, and selects a value in the sub-interval. Moreover, the computer uses a first factorization algorithm for the value V for determining operands A′, B′, where the modular multiplication result of the operands corrected by the coarse-grained correction is in the sub-interval. The computer repeatedly determines A′ plus varying ε-values as A″ values, and determines B″ values, so that the modular multiplication corrected by the coarse-grained correction is in the sub-interval.

### BACKGROUND

The invention relates generally to a method, system and computer program product for generating test data, and more specifically, to generating test data for verifying a modular correction of a modular multiplication performed by a multiplier unit for very wide operands using a computer system.

In modern information technology (IT), hardware and software requirements enrich each other. Sometimes there are faster advances in hardware allowing new software concepts to be developed, and sometimes software is advancing faster driving new requirements for hardware capabilities. One of these advances on the software side is the block chain technology allowing completely distributed ledger systems without any central point of control. In parts, this technology may be used for workloads for electronic business transactions. One of the fundamental technologies used is based on an elliptic curve cryptography (ECC) which builds on operations such as point add and point double. These point operations usually get broken into a sequence of wide modular add, half, and multiply operations with a prime modulus. Commonly, wide modulus prime arithmetic for integer values have 256 bit up to 521 (in words: five-hundred-twenty-one) bit operands, and in some cases, today, up to 8 k bit operands which may even be extended in the future. Furthermore, NIST (US National Institute of Standards and Technology) and Edward curves are used from which appropriate prime numbers for the operations can be derived.

On the other side, there are hardware processors whose registers for add and multiply operations are typically in the size of a memory word (e.g., 32 or 64 bit) with the added ability to also address double word integers. However, the above-mentioned large bit numbers for operands are typically beyond the capability of standard processors for performing add and multiply operations or even modular add and multiply operations as a single instruction in a fully pipelined manner. Specially, the modular multiplication for those wide numbers is compute intensive and hard to verify. Thus, the modular multiplication of two wide integer numbers A and B usually gets performed as a binary multiplication producing a binary product M=A*B followed by a modulo operation producing the result R=M mod P. It should be noted that M can be expressed as the sum of R and a multiple of P, i.e., M=R+k*P, where k is an integer. In a naïve implementation, the modular reduction of M could be performed by subtracting multiples of P from M until the difference is between 0 and P. Each of these subtractions can be formally verified, even for integers with a few hundred bits. However, this scheme is way too slow. Therefore, more elaborate algorithms and hardware implementations are used reducing the binary product with just a few steps. Usually, they apply coarse-grained and fine-grained corrections to the binary product.

However, this approach is more error prone, and therefore intensive testing of the fast hardware implementation in order to ensure that under all circumstances correct results can be expected. The problem is that fast hardware multiply implementations cannot be fully formally verified. Although it may be possible to formally verify the coarse-grained correction operations like the used multiplier, the correction terms and the fine-grained correction terms cause a lot of trouble and are indeed mathematically very tricky.

Therefore, the fast hardware multiply implementation results must be tested or verified with test data. Different test types and their generations are known, e.g., based on random number simulations, classical functional verification tests, biased/directed test cases are possible but do not lead to 100% test coverage. The reason for this: random simulation and biased/directed test cases have only a bad coverage of possible operands, e.g., a verification of (A*B)% P (wherein A and B are wide operands of 256 to 521 bits and a prime number) cause a state explosion: P256: 2\hat{ }(2*256) which is about 1.3*10\hat{ }154 states. Testing all possible cases and combinations with a 5 GHz processor, assuming one instruction per cycle would require 8.7×10\hat{ }136 years. This is by any means far too long.

On the other side, simulations with random numbers can only cover a fraction of the large variety of states. However, for commercially usable and reliable fast hardware multiply implementations, a new approach may be required.

### SUMMARY

According to one aspect of the present invention, a method for generating test data for verifying a modular correction of a modular multiplication performed by a multiplier unit for very wide operands may be provided. The multiplier unit may perform a modular multiplication by performing a binary multiplication of two operands A, B and performing a coarse-grained modular correction such that an intermediate result is within a range CR much smaller than P\hat{ }2 (i.e., power of 2), where P is a prime number used as modulus for the modular multiplication.

The multiplier unit may also perform a fine-grained modular correction to the intermediate result achieving a result of the modular multiplication, where the result is within an interval of [0 to P), whereby different correction values are applied to different intervals of the intermediate result for the fine-grained correction.

The method may include selecting two adjacent intervals of the intermediate result, defining a sub-interval closely around a boundary between the selected adjacent intervals, and selecting a value V in the sub-interval. Furthermore, the method may also include using a first factorization algorithm for the value V for determining operands A′, B′, where the modular multiplication result R′ of the operands A′ and B′ corrected by the coarse-grained correction is in the sub-interval, repeatedly determining A′ plus varying ε-values as A″ values, and determining B″ values so that the modular multiplication corrected by the coarse-grained correction is in the sub-interval, thereby generating the test operand data A″ and B″.

According to another aspect of the present invention, a test data generation system generating test data for verifying a modular correction of a modular multiplication performed by a multiplier unit for very wide operands may be provided. The multiplier unit may perform a modular multiplication by performing a binary multiplication of two operands A, B and performing a coarse-grained modular correction such that an intermediate result is within a range CR much smaller than P\hat{ }2 , where P is a prime number used as modulus for the modular multiplication, as well as performing a fine-grained modular correction to the intermediate result achieving a result of the modular multiplication, where the result is within an interval of [0 to P), whereby different correction values are applied to different intervals of the intermediate result for the fine-grained correction.

The test data generation system may include a processor and a memory communicatively coupled to one or more processors, where said memory stores program code instructions that when executed enable said one or more processor, to select two adjacent intervals of the intermediate result to define a sub-interval closely around a boundary between the selected adjacent intervals and to select a value V in the sub-interval.

The one or more processors may further be enabled to use a first factorization algorithm for the value V for determining operands A′, B′, where the modular multiplication result R′ of the operands A′ and B′ corrected by the coarse-grained correction is in the sub-interval. Furthermore, the one or more processors may also be enabled to repeatedly determine A′ plus varying ε-values as A″ values, and determine B″ values, so that the modular multiplication corrected by the coarse-grained correction is in the sub-interval thereby generating the test operand data A″ and B″.

The proposed method for generating test data for verifying a modular correction of a modular multiplication performed by a multiplier unit for very wide operands may offer multiple advantages, technical effects, contributions and/or improvements:

It may allow a pretty targeted generation of test data for a modular correction of a modular multiplication performed by a multiplier unit for very wide operands. When using classical random generation of test data, many test data sets may be generated in areas of the test data that have very low probability of causing problems in the fast hardware implementation.

However, it can be shown that test data in certain areas may cause the majority of problems of hardware implementations for the fast hardware modular multiplication. This problem may increase the larger the number of bits of the very wide operands becomes, e.g., larger than 255 bits. A naïve implementation of the fast modular multiply operation would take far too long. The problem with the faster and more elaborate techniques for modular multiply is that the combination of coarse-grained and fine-grained approximation of correction terms cannot formally be verified. Hence, a concentration of the test effort on “corner cases” around the used prime number P and multiples thereof may advantageously be used. This is exactly, what the proposed concept delivers. A focus on those test data may have the highest probability to discover bugs in the fast hardware implementation design.

This may give a commercially available hardware implementation for a fast modular multiply operation for very wide integers a much higher reliability. This may be especially valuable in case the modular multiplication unit may be used in cryptography applications and/or block chain applications.

In the following, additional embodiments of the inventive concept—applicable for the method as well as for the system—will be described.

According to a preferred embodiment of the method, the varying ε-values may be generated randomly or based on a preselected algorithm. Thereby, it may be ensured that the varying ε-values may be mathematically much smaller than A′. This may ensure that a plurality of test data may be generated around critical period boundaries where a chance to generate test data that provoke a malfunction of the unit under test—i.e., the multiplier unit—may be significantly higher than in other regions.

According to an embodiment, the first factorization may be performed by determining n1 as └sqrt(V)┘—i.e., floor operator—determining n2 as sqrt(V−(n1)\hat{ }2)┐—i.e., using the ceiling operator—determining A′ as (n1+n2), and determining B′ as (n1−n2). Hence, A′ and B′ may be built using simple linear operations with only using little computation overhead.

According to an embodiment, A and B may be an integer value having a number of bits between 255 to 2\hat{ }13. This may also include the interesting 2\hat{ }521 number of bits of the NIST curves. Generally, the proposed method may be applicable to nearly any number of bits for the integer value. However, below 255 bits, there may only be little incentive to use the proposed method because conventional multiplication techniques may be used advantageously. The higher the number of bits may become, the more attractive the proposed method may be. Also integer number with more than 2\hat{ }13 bits are possible.

According to an embodiment, the intervals may comply with [s*P, t*P], where the range CR may be within the intervals, and where s, t may be integer values, and s and t are as small as possible such that the range CR is partitioned into a plurality of intervals [j*P, (j+1)*P] for all integers j in s≤j≤(t−1). It may be noted that s and t may also have negative values. In order to reduce an intermediate result Ri with j*P≤Ri<(j+1)*P into the interval [0, P), a correction of −j*P needs to be applied. This correction may be the combined effect of the fine-grained correction and modular addition. Thus, CR may be partitioned into a set of intervals where all values within a given interval require the same combined correction. Errors in the implementation are more likely to occur on a transition from one correction value to the next, i.e., near the boundary of the intervals.

According to an embodiment, the intervals may comply with the following conditions: a value q may be determined such that 2\hat{ }q is closest to the prime P, where the range CR may be part of the interval [s*2\hat{ }q, t*2\hat{ }q], where s, t, are integer values, and s, and t are as small as possible. Also here, the values of s, t can be negative. These conditions may ensure that a splitting is not performed into any possible multiple of primes but into multiples of the power of 2. The implementation of the modular correction might only look at a few leading bits of the wide integer intermediate result to select the appropriate fine-grained correction. For such an implementation, intervals with the multiples of 2\hat{ }q are a better choice.

According to an alternative embodiment, the intervals may comply with the following conditions: a correction value X for each intermediate result may be determined, by a sub-unit of the multiplier; thereby a group of correction values SCV may be built. This embodiment may also include determining from a specification of the sub-unit a minimal value min(X) and a maximum value max(X) for which the sub-unit determines the correction value X, such that range CR gets thus partitioned into a plurality of intervals of [min(X), max(X)]. The idea behind: the multiplier unit needs to select the right correction value. Therefore, for each of these values X, the smallest and biggest value of the intermediate result may be determined by inspection of the implementation. The resulting min and max values may define the interval. It may also be noted that overlapping intervals may explicitly be allowed.

According to a further embodiment, at least two of the intervals [min(x1), max(x1)] and [min(x2), max(x2)] may overlap, and for such an interval pair, the subinterval may be chosen such that it may completely include the intersection of the intervals [min(x1), max(x1)] and [min(x2), max(x2)]. In general, overlapping intervals usually occur when the hardware multiplier and the unit selecting the fine-grained correction use a redundant number representation: This represents a frequent case.

According to another embodiment, the selection of the two adjacent intervals may include a looping sub-method—i.e., a related algorithm or mechanism—and a selection sub-method—i.e., also an algorithm or mechanism—where in each loop of the looping sub-method a pair of adjacent intervals may be selected and for that interval pair test operand data A″ and B″ are generated.

According to a further embodiment, the selection sub-method may include using a counter for each of the adjacent intervals (can be in the verification tool (SW), pre-silicon test counters or hardware counters), counting, using the counter, for an adjacent interval pair of intervals how often their sub-interval was hit by a test operand data pattern, and selecting, using the selection sub-method, a next interval pair based on the counter values, by selecting the next interval having the lowest counter value.

According to another embodiment, it may also be possible using additionally an alternative method for the core test data generation, where also the alternative method increments the counters when their data patterns hit the corresponding sub-interval. I.e., the here proposed test data generation method may be integrated with an, e.g., random generation of test data.

According to another embodiment, the prime number P used for applied modular arithmetic may be selected from NIST primes, Edwards primes and generalized Mersenne primes. The coarse-grained correction may, e.g., be based on Solinas reduction tables and the NIST primes go back to technology supplied by the US National Institute of Standards and Technology.

Furthermore, embodiments may take the form of a related computer program product, accessible from a computer-usable or computer-readable medium providing program code for use, by, or in connection, with a computer or any instruction execution system. For the purpose of this description, a computer-usable or computer-readable medium may be any apparatus that may contain means for storing, communicating, propagating or transporting the program for use, by, or in connection, with the instruction execution system, apparatus, or device.

According to another aspect of the present invention, a method, system and computer program product for generating test data for verifying a modular correction of a modular multiplication includes selecting, by one or more processors, two adjacent intervals of an intermediate result obtained from a coarse-grained modular correction on a binary multiplication of two operands A, B and defining a sub-interval closely around a boundary between the selected adjacent intervals, wherein the intermediate result is within a range CR smaller than P\hat{ }2, with P being a prime number used as modulus for the modular multiplication, selecting, by the one or more processors, a value V in the sub-interval, using, by the one or more processors, a first factorization algorithm for the value V for determining operands A′, B′, where the modular multiplication result R′ of the operands A′ and B′ corrected by the coarse-grained correction is in the sub-interval, repeatedly determining, by the one or more processors, A′ plus varying ε-values as A″ values, and determining, by the one or more processors, B″ values so that the modular multiplication corrected by the coarse-grained correction is in the sub-interval, thereby generating a test operand data A″ and B″.

According to one aspect, the varying ε-values are generated randomly or based on a preselected algorithm. Furthermore, the first factorization is performed by: determining, by the one or more processors, n1 as └sqrt(V)┘, determining, by the one or more processors, n2 as ┌sqrt( V−(n1)\hat{ }2)┐, determining, by the one or more processors, A′ as (n1+n2), and determining, by the one or more processors, B′ as (n1−n2).

According to one additional aspect, each of A and B is an integer value having a number of bits between 255 to 2\hat{ }13, and the intervals comply with [s*P, t*P], a range CR is within the intervals, and s, t are integer values, and s and t are as small as possible, such that the range CR is partitioned into a plurality of intervals [j*P, (j+1)*P] for all integers j in s≤j≤(t−1). Also, the intervals comply with at least one of: determining, by the one or more processors, a value q such that 2\hat{ }q is closest to a prime number P, the range CR is part of an interval [s*2\hat{ }q, t*2\hat{ }q], where s, t, are integer values, and s, and t are as small as possible, such that the range CR is partitioned into a plurality of intervals [j*2\hat{ }q, (j+1)*2\hat{ }q] for all integers j in s≤j≤(t−1).

Additionally or alternatively, the intervals comply with at least one of: determining, by the one or more processors, using a sub-unit of the multiplier, a correction value X for each intermediate result, thereby building a group of correction values SCV, and determining, by the one or more processors, from a specification of the sub-unit a minimal value min(X) and a maximum value max(X) for which the sub-unit determines a correction value X, such that the range CR gets thus partitioned into a plurality of intervals of [min(X), max(X)]. In one aspect, at least two of the intervals [min(x1), max(x1)] and [min(x2), max(x2)] overlap, and for such an interval pair, a subinterval is chosen such that it completely includes an intersection of the intervals [min(x1), max(x1)] and [min(x2), max(x2)].

In one additional aspect, a selection of two adjacent intervals includes a looping sub-method and a selection sub-method, in each loop of the looping sub-method a pair of adjacent intervals is selected, and for that interval pair test operand data A″ and B″ are generated. The selection sub-method further including using, by the one or more processors, a counter for each of the adjacent intervals, counting, by the one or more processors, using the counter, for an adjacent interval pair of intervals how often their sub-interval was hit by a test operand data pattern, and selecting, by the one or more processors, using the selection sub-method, a next interval pair based on counter values, by selecting a next interval having a lowest counter value.

In one further aspect, the method, system and computer program product further include incrementing, by the one or more processors, the counters when their data patterns hit a corresponding sub-interval. Additionally, a prime number P used for applied modular arithmetic is selected from at least one of NIST primes, Edwards primes, and generalized Mersenne primes.

### BRIEF DESCRIPTION OF THE DRAWINGS

It should be noted that embodiments of the invention are described with reference to different subject-matters. In particular, some embodiments are described with reference to method type claims, whereas other embodiments are described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be disclosed within this document.

The aspects defined above and further aspects of the present invention are apparent from the examples of embodiments to be described hereinafter and are explained with reference to the examples of embodiments, to which the invention is not limited.

Preferred embodiments of the invention will be described, by way of example only, and with reference to the following drawings:

FIG. 1 shows a block diagram of a method for generating test data for verifying a modular correction of a modular multiplication performed by a multiplier unit for very wide operands, according to an embodiment of the present invention;

FIG. 2 shows a block diagram of a modular multiplication with correction terms, according to an embodiment of the present invention;

FIG. 3 shows a block diagram including a flow of steps supporting the inventive concept; according to an embodiment of the present invention;

FIG. 4 shows a diagram supporting an explanation of the general multiplication method for a first example, according to an embodiment of the present invention;

FIG. 5a shows a diagram of intervals of test data and related sub-intervals for the context of FIG. 4, according to an embodiment of the present invention;

FIG. 5b shows a data table for the context of FIG. 4, according to an embodiment of the present invention;

FIG. 6 shows intervals with related sub-intervals for a second example, according to an embodiment of the present invention;

FIG. 7a shows additional data structures for explaining the second example, according to an embodiment of the present invention;

FIG. 7b shows additional data structures for explaining the second example, according to an embodiment of the present invention;

FIG. 7c shows additional data structures for explaining the second example, according to an embodiment of the present invention;

FIG. 8 shows a reduced radix format with a representation of 2*P in non-redundant binary format, according to an embodiment of the present invention;

FIG. 9a shows intervals and data structures for the third example, according to an embodiment of the present invention;

FIG. 9b shows intervals and data structures for the third example, according to an embodiment of the present invention;

FIG. 9c shows intervals and data structures for the third example, according to an embodiment of the present invention;

FIG. 10a also shows interval examples for the third example, according to an embodiment of the present invention;

FIG. 10b also shows interval examples for the third example, according to an embodiment of the present invention;

FIG. 11 shows a block diagram of the inventive test data generation system generating test data for verifying a modular correction of a modular multiplication performed by a multiplier unit for very wide operands, according to an embodiment of the present invention; and

FIG. 12 shows a computing system including the system according to FIG. 11, according to an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

In the context of this description, the following conventions, terms and/or expressions may be used:

The term ‘test data’ may denote integer operands with a bit size of at least 255 bits. They may be generated by the proposed concept in order to test a fast modular multiplier unit, because a scientific proof of concept for the correctness of the first modular multiplier unit is technically not possible.

The term ‘modular correction’ may denote a term (at least one) required for the modular reduction for a modular (addition or) multiplication operation. The modular reduction may be obtained by a combination of coarse-grained correction terms and fine-grained correction terms. For example, for P=17, the binary product of 16 and 13 is 208. The modular reduction can be performed as R1=208−10*P=208−170=38 followed by R=R1−2*P=38−34=4. In this example, the subtraction of 10*P is a coarse-grained correction, and the subtraction of 2*P is a fine-grained correction.

The term ‘modular multiplication’ may denote a mathematical operation in the sense of:

R=(A*B)% P, where P is a prime number and “%” is the modular operator.

The term ‘multiplier unit’ may denote here a hardware (eventually combined with software) implementation for a fast modular multiplication for very wide operands, e.g., at least 255 bits wide. The bit size of a wide operand may go up to 8 k bits and even beyond.

The term ‘binary multiplication’ may denote the classical multiplication of two operands A, B, namely, A*B.

The term ‘coarse-grained modular correction’ may denote a first reduction step of a modular multiplication, after the binary multiplication has been performed.

The term ‘fine-grained modular correction’ may denote a second reduction step of the modular multiplication, after the coarse-grained modular correction has been applied. The fine-grained modular correction terms may be derived based on the coarse-grained modular correction terms.

The term ‘sub-interval closely around a boundary’ may denote a comparably small range of integer values around a value of n*P, n=0, 1, 2 . . . , where P is a prime number. When one may have two intervals [a, b] and [b,c], their boundary is b, and a sub-interval the boundary of the two intervals may denote a comparably small range of integer values around a value b.

The term ‘factorization algorithm’ may denote a method to determine numbers such that their product is the given result R or an approximation thereof.

The term ‘NIST primes’ may denote a field of prime numbers provided by the US national Institute of science and technology. A prime is a number which can be divided only by one or itself.

The term ‘Edward primes’ may denote prime numbers based on elliptic curves in the elliptic curve cryptography field (ECC). An example may be the Edwards curve used in ECC, namely, Curve 448.

The term ‘Mersenne primes’ may denote a special version of prime numbers, namely those that may be expressed in the form of (2\hat{ }p−1) and ‘generalized Mersenne Primes’ may be expressed as P_M=2\hat{ }p±Σ_(i=0)\hat{ }(I−1) [symbol] a_(t_i)*2\hat{ }(t_i) [symbol] , and I<<p. In ECC today, I is single digit, usually five or less.

In the following, a detailed description of the figures will be given. All instructions in the figures are schematic. Firstly, a block diagram of an embodiment of the inventive method for generating test data for verifying a modular correction of a modular multiplication performed by a multiplier unit for very wide operands is given. Afterwards, further embodiments, as well as embodiments of the test data generation system generating test data for verifying a modular correction of a modular multiplication performed by a multiplier unit for very wide operands will be described.

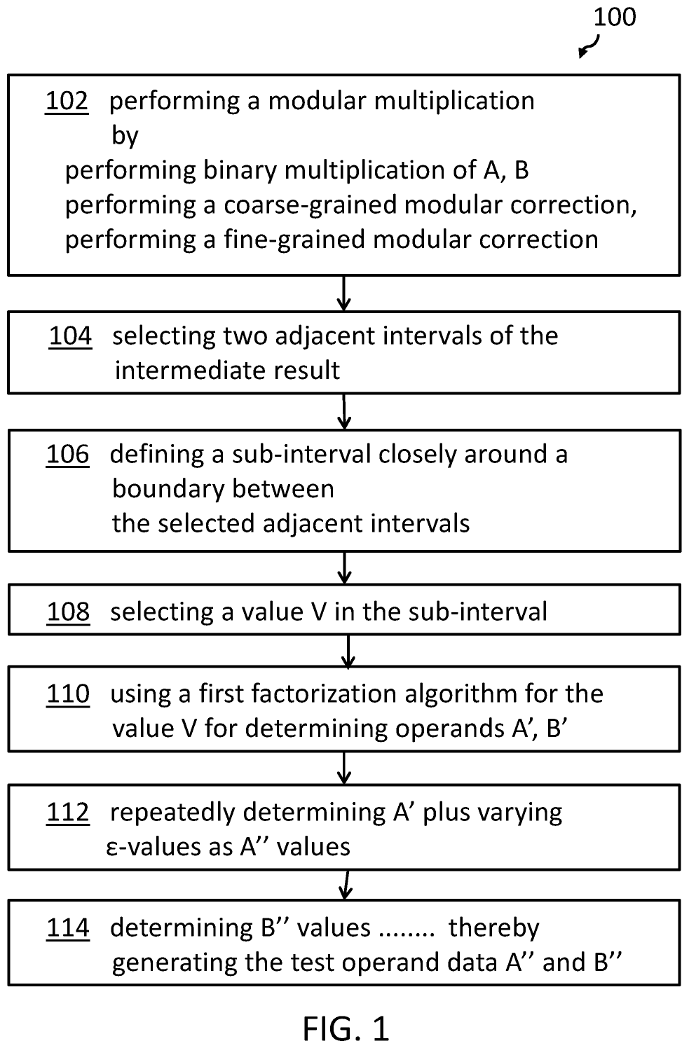

FIG. 1 shows a block diagram of a preferred embodiment of the method 100 for generating test data for verifying a modular correction of a modular multiplication performed by a multiplier unit—which may be implemented in hardware, software or a mixture thereof—for very wide operands. The operands may be represented by integers with a bit-width of 255 up to 8 k. Also, the bit-width of 521 (in words “five-hundred-twenty-one” is as an important factorization element included) is part of the range. Lower numbers of bits are only rarely useful because such data ranges may be better addressed by a naïve multiplier solution.

It is also assumed that the multiplier unit performs a modular multiplication by performing, 102, a binary multiplication of two operands A, B, performing, 102, a coarse-grained modular correction such that an intermediate result is within a range CR much smaller than P\hat{ }2, where P is a prime number used as modulus for the modular multiplication, and performing, 102, a fine-grained modular correction to the intermediate result achieving a result of the modular multiplication, where the result is within an interval of [0 to P), whereby different correction values—e.g., the same of each interval or also different ones in different intervals—are applied to different intervals of the intermediate result for the fine-grained correction.

The method 100 includes selecting, 104, two adjacent intervals of the intermediate result, defining, 106, a sub-interval closely around a boundary between the selected adjacent intervals, and selecting, 108, a value V—e.g., randomly—in the sub-interval.

Then, the method 100 is using, 110, a first factorization algorithm—any factorization algorithm may be used—for the value V for determining operands A′, B′, wherein the modular multiplication result R′ of the operands A′ and B′ corrected by the coarse-grained correction is in the sub-interval.

Next, the method 100 includes repeatedly determining, 112, A′ plus varying ε-values as A″ values, and determining, 114, B″ values so that the modular multiplication corrected by the coarse-grained correction is in the sub-interval, thereby generating the test operand data A″ and B″. Typically, epsilon<<A′ should be understood.

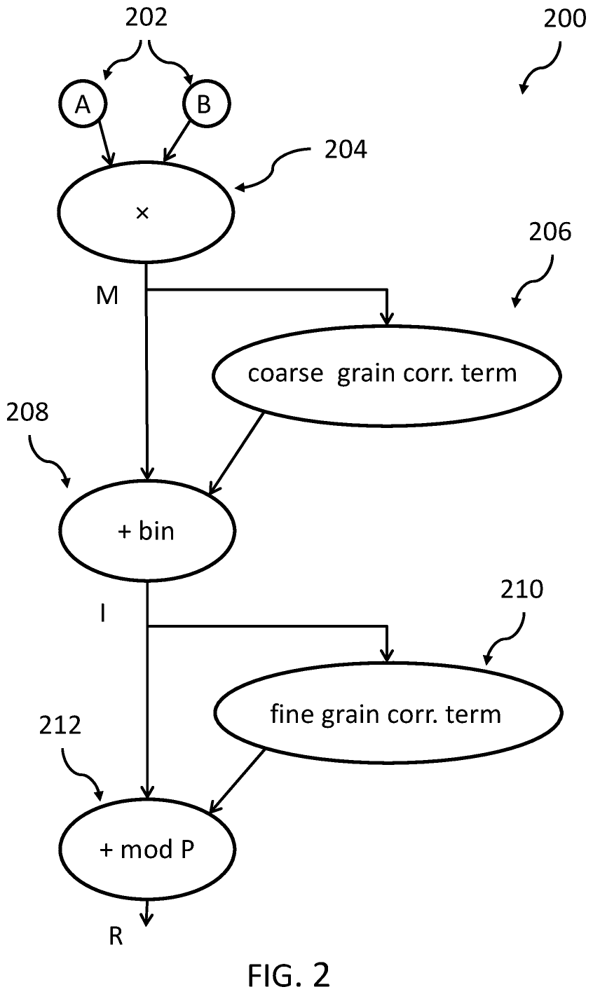

FIG. 2 shows a block diagram 200 of an embodiment of a modular multiplication with correction terms. For a proper explanation, some background information may be instrumental:

A modular add operation R=(A+B)% P, where“%” is the modulus operator and P is a prime number, can be performed comparably easy because the binary sum is 0≤A+B<2*P. In hardware it can be realized by a 2's complement adder:

R1=A+B

R2=R1−P

R=R2 if R2≥0 or R=R1 if R2<0.

On the other side, the modular multiply operation R=(A*B)% P is a much harder problem because 0≤A*B<P*P. Thus, the modular correction is not just a conditional subtraction of 1*P, and therefore, foremost prime curves of the modular correction is computationally intensive and mathematically tricky. This applies in particular if the operands A, B have values with a very high number of bits, e.g., larger than 255.

For generalized Mersenne Primes, the modular multiply operation R=(A*B)% P can be determined by:

A*B=bin (Cn . . . CO), where each Ci is a 32-bit word.

Then, multiple correction terms Ti get formed out of the Ci's. The modular product gets obtained by modular adding the terms Ti such that:

R=(A*B)%P=T0⊕T1 ⊕T2 ⊕ . . . ⊕ Tk, wherein ⊕ is an add-mod-P operation.

A naïve hardware implementation for this is relatively easy to test as a loop of modular additions. However, a fast hardware implementation applies a coarse-grained and a fine-grained correction. This is shown in FIG. 2 for the modular multiply operation.

The two operands A, B 202 firstly undergo a binary product A*B 204 operation, resulting in the product M. Then, the coarse grain correction terms T0, T1, T2, . . . Tk 206 are determined and are added by a binary adder 208 in parallel. This results in the intermediate result I. The fine-grained correction terms 210 depend, of course, on the value of the intermediate result I and its number representation. In order to apply the fine-grained correction terms 210, a mod P adder 212 is used to determine the final result R.

The structure of FIG. 2 also applies to the Barrett reduction which can perform the modular reduction for any arbitrary prime. Let k be the bit width, and N=floor(2\hat{ }(2k)/P). The Barrett reduction for the product M=A*B then performs the steps:
1. Q=(M>>(k−1))*N
2. R1=(Q>>(k−1))*P
3. R2=M[k:0]−R1[k:0] (low order k+1 bits),
and then corrects R2 by conditionally adding 2\hat{ }(k+1) if R2 is negative or subtracting P or 2P to achieve the R=(A*B)% P. Here, the steps 1. and 2. determine the coarse-grained correction (206), and step 3 applies it to the product. The subsequent correction of R2 is the fine-grained correction like in (210) and (212).

The fast hardware implementation cannot be formally verified. This is why the problem of how to verify its correctness remains. The method and system proposed here addresses this problem.

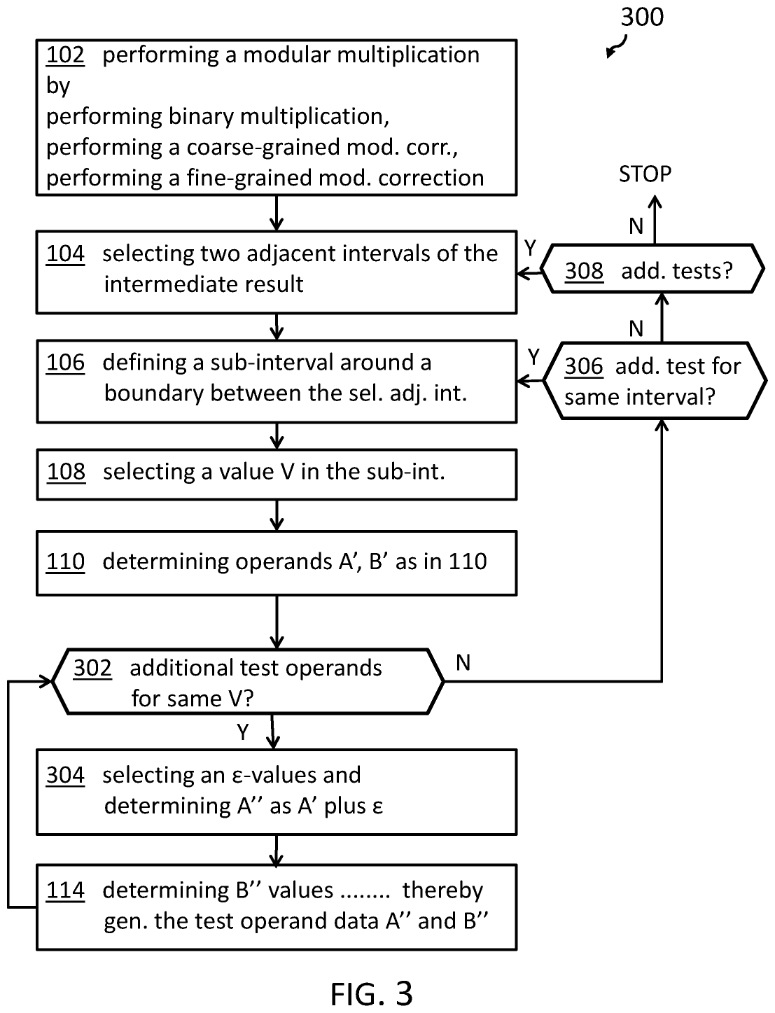

FIG. 3 shows a block diagram of an embodiment including a flow of steps supporting the inventive concept. It closely leans on the flow chart of FIG. 1 and equivalent steps (e.g., 102, 104, 106, . . . ) are not repeatedly described.

However, after the determining the operands A′, B′ (step 110), a determination 302 is made whether additional test operands are required for the same value V (a so-called seed value). In case of a positive outcome—case “Y”—a small ε value is selected so that a value A″ can be determined, 304, as A′+ε. Based on this, also a value of B″ can be determined (as 114 in FIG. 1) so that test data operands can repeatedly be produced because the process loops back to the determination whether additional test operands for the same V are required, 302.

In case of a negative outcome of the determination 302—case “N”—the process follows the path to determination 306 whether additional test data are required for the same interval. In case of a positive outcome—case “Y”—the process re-enters the general flow for operation 106. In case of a negative outcome—case “N”—a new determination 308 is performed whether additional test data are required at all. In case of a positive outcome—case “Y”—the process re-enters the general flow 300 with operation 104 in which two adjacent intervals of the intermediate result are determined. In case of a negative outcome—case “N”—the process ends, i.e. stops (STOP).

Here, it may also be noted that as a factorization algorithm for the above flowchart the following theorem can be applied:

N=(x+y)*(x−y)=x\hat{ }2—y\hat{ }2, where \hat{ } is the power operator.

With n1=└sqrt(V)┘=>y=┌sqrt(V−(n1)\hat{ }2)┐, wherein └ . . . ┘ is the floor operator and └┌ . . . ┐ is the ceiling operator.

An initial guess could be x=n1=└sqrt(V)┘.

This approach results in approximated integer input operands A=(x+y) and B (x−y).

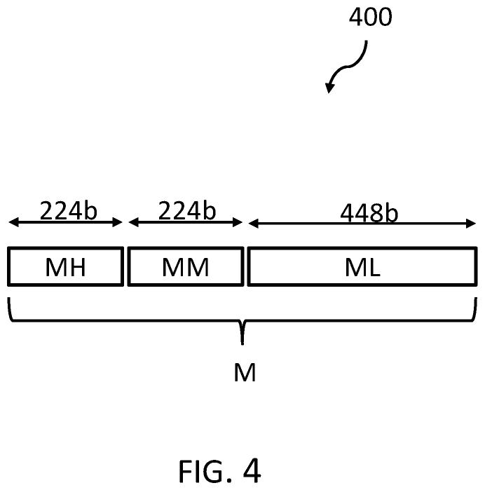

FIG. 4 shows a diagram 400 supporting an explanation of the general multiplication method for a first example, namely, the Curve 448 (i.e. the Curve 448-Goldilocks) which belongs to the Edwards curves. Its underlying prime is P=2\hat{ }448−2\hat{ }224−1. If A, B are two 448-bit (448 b) binary integers in the range of [0, P), then their binary product M=A*B is an 896-bit number in the range [0, P\hat{ }2).

Curve 448 has a comparably easy course-grain correction, in achieving the intermediate result as:

S=ML+(1+2\hat{ }224)*MM+(1+2*2\hat{ }224)*MH, where

M=M[895:0]=MH*2\hat{ }672+MM*2\hat{ }448+ML, where

ML=M[447:0], (this number represents the low-order 448 bits),

MH=M[895:672] (this number represents the leading 224 bits),

MM=M[671:448] (this number represents the remaining (middle) 224 bits).

As a consequence, the intermediate result lays in the range of [0, 5P). Hence, the fine-grained correction—which conditionally selects a value of {0, −P, −2P, −3P, −4P}—together with the modular addition then reduces the intermediate result S into the range [0, P) and define a result R of the modular multiplication.

The relationships between MH, MM, and ML building M is shown in FIG. 4. It should also be noted that the indicators 224 b and 448 b refer to the bit-width.

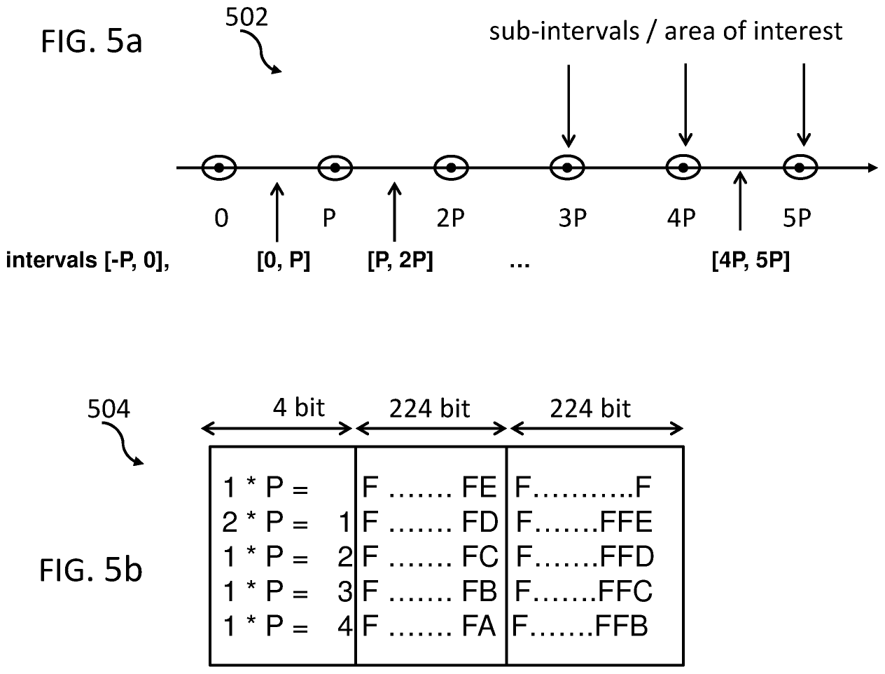

FIG. 5a and FIG. 5b show a diagram 502 and a table 504 of intervals of test data and related sub-intervals with a data result table in context of FIG. 4. As discussed above, the uncertainty range of the result R lies in the range of 0 to 5P. This range is shown as dots in the diagram 502. The dots are encircled by ellipses characterizing sub-intervals or areas of interest for the modular multiplication test data generation. It turned out, that in sub-ranges around the interval boarder the probability for wrong results of the fast hardware implementation is highest.

So, the intervals are denoted as [−P, 0), [0, P), [P, 2P), . . . , [4P, 5P). In this case, the design under test is assumed to be a black box, and one only knows that the intermediate result Ri is in the range of [0, 5P). Since the result of the fine-grained correction and modular addition is in the range of [0, P), one knows that when j*P≤Ri<(j+1)*P, then the combined correction of the fine-grain correction and the subsequent modular addition must be minus j*P, so that R=Ri−j*P.

It should be noted that the fine-grained correction could over- or undershoot, and would then be corrected by the modular addition. Nevertheless, one knows that around the multiples of P the calculation of the fine-grained correction and modular addition is very likely to change. These are areas of special interest which one would like to stress with a test pattern generation.

Thus, for this black box case, one picks the intervals as mentioned above. Additionally, one picks the sub-intervals for example for the pair [0, P] and [P, 2P] around P, e.g., as [P−2\hat{ }440, P+2\hat{ }440].

As a consequence, multiples of the prime P and their hexadecimal representation looks like the table of FIG. 5b. For the most significant bits, a block of 4 bits is used because one also wants to represent negative values.

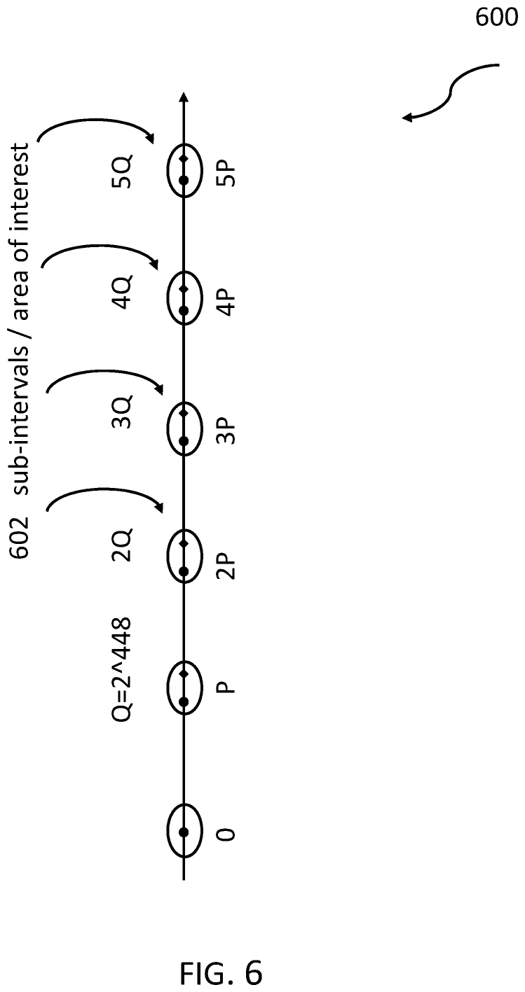

FIG. 6 shows a diagram 600 of intervals with related sub-intervals 602 for a second example which is also based on the Curve 448. Also, the intermediate result Ri is still in the range of [0, 5*P). Exact checking of the multiples of P is computationally expensive and hardware solutions therefore often consider some leading bits of the intermediate result.

For such a case, one takes the intervals as [−Q, 0] [0, Q], [Q, 2Q], . . . , [4Q, 5Q],
where Q=2\hat{ }2448. Furthermore, one picks the sub-interval, e.g., for the pair [2, 2Q] and [2Q, 3Q] around boundary 2Q such that it also includes the multiple of 2P. The ellipses shown in FIG. 6 encircle exactly these sub-intervals or areas of interest for the system under test.

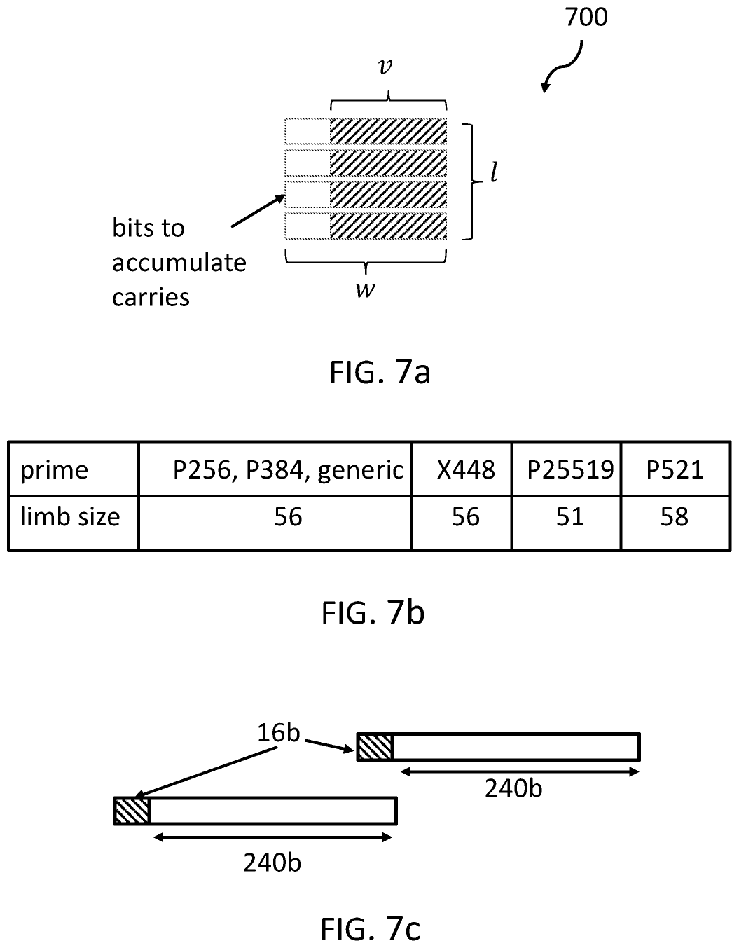

FIGS. 7a, 7b, and 7c show additional data structures for explaining a third example. For this example, it is assumed that more detailed information about the implementation of the fast modular multiplier unit and its subcomponents are known. To speed up wide integer arithmetic (software and hardware), it is very common to use redundant number formats, like a “carry-sum” representation or reduced radix. In the reduced radix format 700, one has a word size w and a limp size v, as shown in FIG. 7a. An n-bit number gets represented with 1 limps, where 1=round_up(n/v). Each of the high words overlap by w-v bits. These bits are used to accumulate carries. Additions of two n-bit numbers are done by limp-wise addition, as long as the w-bit words do not overflow.

Common limb sizes for 64-bit words may be used from the OpenSSL ECC library. Examples for limp sizes and related prime curves are shown in FIG. 7b.

For a better comprehensibility, one presents the 448-bit numbers with two limps. The word size is 256 b and the limb size is 240 b. That way, the two words overlap by 16 bits. In the higher 256 b word, the 448-bit number only occupies 208 bits, as shown in FIG. 7c.

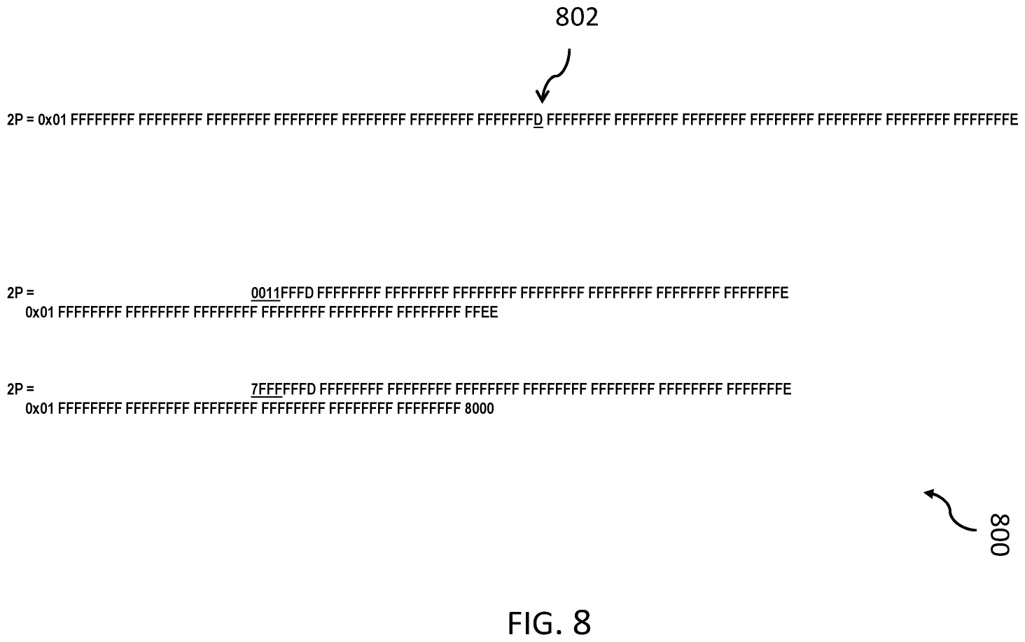

FIG. 8 shows a comparison of the representation of 2*P in non-redundant binary format compared to the reduced radix format with a representation for 2*P with 240-bit limbs. The latter is shown in the last two lines of FIG. 8, where the non-redundant binary format is shown in the first line of FIG. 8. Attention should be given to the “D” 802.

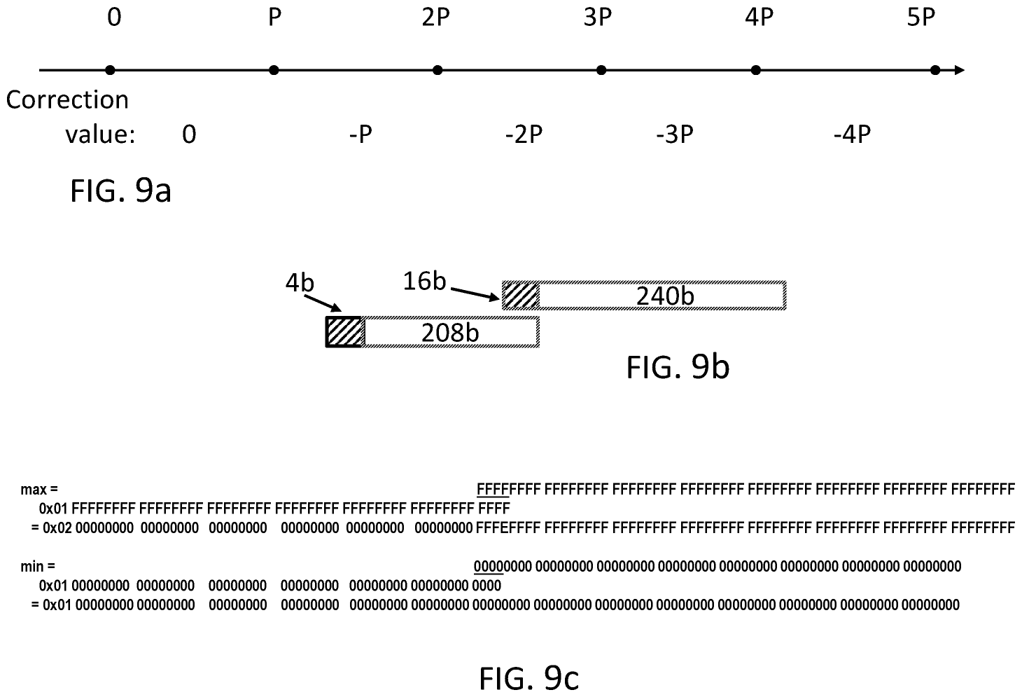

With FIGS. 9a, 9b, and 9c, the description of the third example is continued with intervals and data structures for the third example of FIG. 8. As mentioned above, in the third example, there is more detailed information about the hardware implementation of the modular multiplier unit and its sub-components available. Namely, the intermediate result is in the range of [0, 5P) and is represented in 240-bit limp format with 256-bit words.

The fine-grained correction sub-unit of the multiplier unit selects the correct value from this set SCV={0, −P, −2P, −3P, −4P} as indicated in FIG. 9a. This can be achieved by just observing the leading four bits of the leading limp, as indicated in FIG. 9b (abc b stands for abc number of bits). For each value of the set SCV, one derives the minimal and maximum value. It selects −2P, when the leading bits of the value is 0×1. The minimal and maximal intermediate values are then consequently as indicated by FIG. 9c.

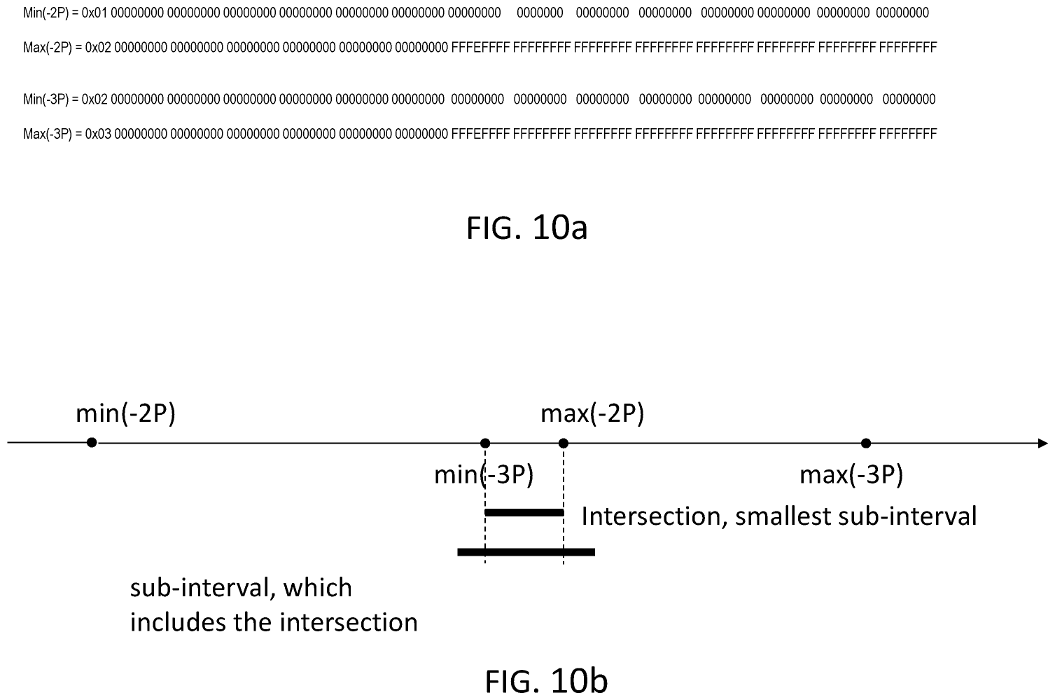

FIGS. 10a and 10b continuous the minimal and maximal values for other “prime periods” namely, for −2P and −3P; compare FIG. 10a. Hence, the intervals is defined as [min(kP), max(kP)], for k=0, −1, . . . , −4. These intervals overlap and obviously as indicated by FIG. 10b, e.g., min(−3P) is smaller than max(−2P).

For this interval pair, one wants to target test patterns which hit the intersection of the two intervals because depending on the representation of their intermediate result from the coarse-grained correction, they get either mapped to −2P or −3P. Thus, one selects the sub-interval as the intersection of the two intervals, or is slightly larger interval which includes the intersection. This is shown in FIG. 10b.

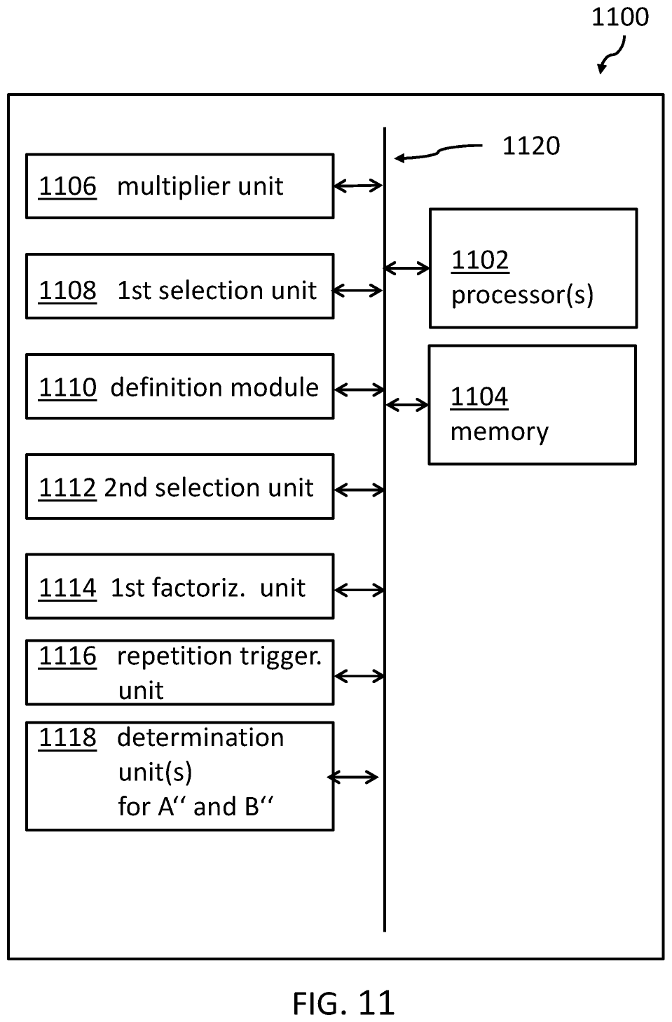

FIG. 11 shows a block diagram of an embodiment of the test data generation system 1100 generating test data for verifying a modular correction of a modular multiplication performed by a multiplier unit 1106 for very wide operands. The multiplier unit 1106 performs a modular multiplication by performing a binary multiplication of two operands A, B and performing a coarse-grained modular correction such that an intermediate result is within a range CR much smaller than P\hat{ }2, wherein P is a prime number used as modulus for the modular multiplication. Furthermore, the multiplier unit 1106 performs a fine-grained modular correction to the intermediate result achieving a result of the modular multiplication, wherein the result is within an interval of [0 to P), whereby different correction values are applied to different intervals of the intermediate result for the fine-grained correction.

The test data generation system 1100 comprises a processor 1102 and a memory 1104 communicatively coupled to one or more processors 1102, where the memory 1104 stores program code instructions that when executed, enable the one or more processor, to select—in particular, by a first selection unit 1108—two adjacent intervals of the intermediate result, to define—in particular, by a definition unit 1110—a sub-interval closely around a boundary between the selected adjacent intervals, select—in particular, by a second selection unit 1112—a value V in the sub-interval, and use a first factorization algorithm—in particular, activating the factorization unit 1114 for the value V for determining operands A′, B′, wherein the modular multiplication result R′ of the operands A′ and B′ corrected by the coarse-grained correction is in the sub-interval.

Furthermore, the one or more processors 1102 are enabled to repeatedly—in particular, by a repetition triggering unit 1116—determine A′ plus varying ε-values as A″ values (in particular, by a determination unit(s) 1118), and determine B″ values, so that the modular multiplication corrected by the coarse-grained correction is in the sub-interval, thereby generating the test operand data A″ and B″. This last step can also be executed by the determination unit(s) 1118.

It shall also be mentioned that all functional units, modules and functional blocks—in particular, the processor 1102, the memory 1104, the multiplier unit 1106, the—first selection unit 1108, the definition module 1110, the second selection module, the first factorization unit, the repetition triggering unit 1116 and the determination unit(s) 1118—may be communicatively coupled to each other for signal or message exchange in a selected 1:1 manner. Alternatively, the functional units, modules and functional blocks can be linked to a system internal bus system 1120 for a selective signal or message exchange.

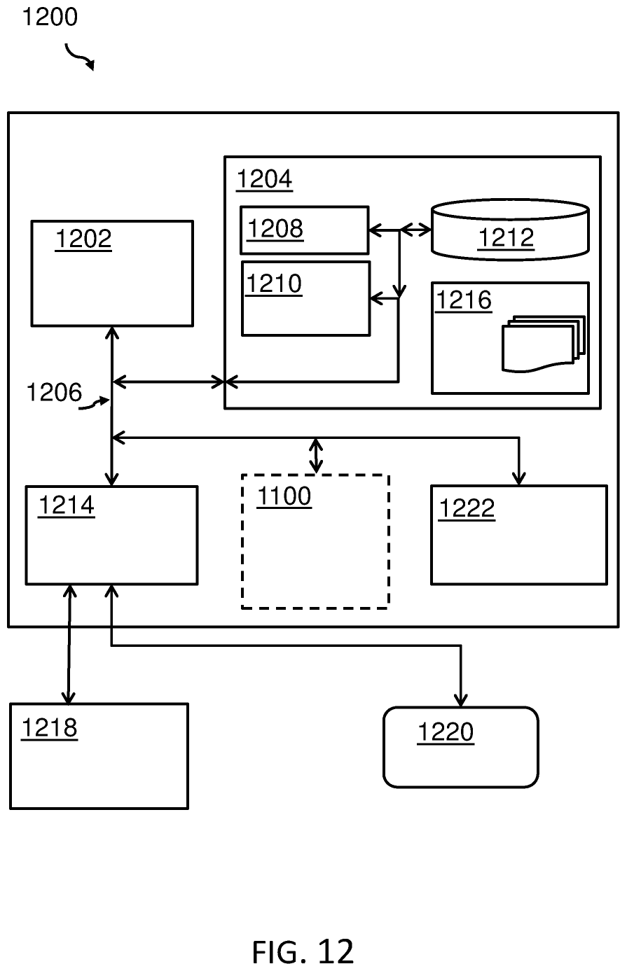

Embodiments of the invention may be implemented together with virtually any type of computer, regardless of the platform being suitable for storing and/or executing program code. FIG. 12 shows, as an example, a computing system 1200 suitable for executing program code related to the proposed method.

The computing system 1200 is only one example of a suitable computer system, and is not intended to suggest any limitation as to the scope of use or functionality of embodiments of the invention described herein, regardless, whether the computer system 1200 is capable of being implemented and/or performing any of the functionality set forth hereinabove. In the computer system 1200, there are components, which are operational with numerous other general purpose or special purpose computing system environments or configurations. Examples of well-known computing systems, environments, and/or configurations that may be suitable for use with computer system/server 1200 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Computer system/server 1200 may be described in the general context of computer system—executable instructions, such as program modules, being executed by a computer system 1200. Generally, program modules may include routines, programs, objects, components, logic, data structures, and so on that perform particular tasks or implement particular abstract data types. Computer system/server 1200 may be practiced in distributed cloud computing environments where tasks are performed by remote processing devices that are linked through a communications network. In a distributed cloud computing environment, program modules may be located in both, local and remote computer system storage media, including memory storage devices.

As shown in the figure, computer system/server 1200 is shown in the form of a general-purpose computing device. The components of computer system/server 1200 may include, but are not limited to, one or more processors or processing units 1202, a system memory 1204, and a bus 1206 that couple various system components including system memory 1204 to the processor 1202. Bus 1206 represents one or more of any of several types of bus structures, including a memory bus or memory controller, a peripheral bus, an accelerated graphics port, and a processor or local bus using any of a variety of bus architectures. By way of example, and not limiting, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computer system/server 1200 typically includes a variety of computer system readable media. Such media may be any available media that is accessible by computer system/server 1200, and it includes both, volatile and non-volatile media, removable and non-removable media.

The system memory 1204 may include computer system readable media in the form of volatile memory, such as random access memory (RAM) 1208 and/or cache memory 1210. Computer system/server 1200 may further include other removable/non-removable, volatile/non-volatile computer system storage media. By way of example only, a storage system 1212 may be provided for reading from and writing to a non-removable, non-volatile magnetic media (not shown and typically called a ‘hard drive’). Although not shown, a magnetic disk drive for reading from and writing to a removable, non-volatile magnetic disk (e.g., a ‘floppy disk’), and an optical disk drive for reading from or writing to a removable, non-volatile optical disk such as a CD-ROM, DVD-ROM or other optical media may be provided. In such instances, each can be connected to bus 1206 by one or more data media interfaces. As will be further depicted and described below, memory 1204 may include at least one program product having a set (e.g., at least one) of program modules that are configured to carry out the functions of embodiments of the invention.

The program/utility, having a set (at least one) of program modules 1216, may be stored in memory 1204 by way of example, and not limiting, as well as an operating system, one or more application programs, other program modules, and program data. Each of the operating systems, one or more application programs, other program modules, and program data or some combination thereof, may include an implementation of a networking environment. Program modules 1216 generally carry out the functions and/or methodologies of embodiments of the invention, as described herein.

The computer system/server 1200 may also communicate with one or more external devices 1218 such as a keyboard, a pointing device, a display 1220, etc.; one or more devices that enable a user to interact with computer system/server 1200; and/or any devices (e.g., network card, modem, etc.) that enable computer system/server 1200 to communicate with one or more other computing devices. Such communication can occur via Input/Output (I/O) interfaces 1214. Still yet, computer system/server 1200 may communicate with one or more networks such as a local area network (LAN), a general wide area network (WAN), and/or a public network (e.g., the Internet) via network adapter 1222. As depicted, network adapter 1222 may communicate with the other components of the computer system/server 1200 via bus 1206. It should be understood that, although not shown, other hardware and/or software components could be used in conjunction with computer system/server 1200. Examples, include, but are not limited to: microcode, device drivers, redundant processing units, external disk drive arrays, RAID systems, tape drives, and data archival storage systems, etc.

Additionally, the test data generation system 1200 generating test data for verifying a modular correction of a modular multiplication performed by a multiplier unit for very wide operands may be attached to the bus system 1206.

According to an embodiment, a method for generating test data for verifying a modular correction of a modular multiplication performed by a multiplier unit for very wide operands, where the multiplier unit performs a modular multiplication by performing a binary multiplication of two operands A, B and performing a coarse-grained modular correction such that an intermediate result is within a range CR much smaller than P\hat{ }2, where P is a prime number used as a modulus for the modular multiplication, performing a fine-grained modular correction to the intermediate result achieving a result of the modular multiplication, where the result is within an interval of [0 to P), whereby different correction values are applied to different intervals of the intermediate result for the fine-grained correction, the method including: selecting two adjacent intervals of the intermediate result, and defining a sub-interval closely around a boundary between the selected adjacent intervals, selecting a value V in the sub-interval, using a first factorization algorithm for the value V for determining operands A′, B′, where the modular multiplication result R′ of the operands A′ and B′ corrected by the coarse-grained correction is in the sub-interval, repeatedly determining A′ plus varying ε-values as A″ values, and determining B″ values so that the modular multiplication corrected by the coarse-grained correction is in the sub-interval, thereby generating the test operand data A″ and B″.

In an embodiment, the varying ε-values are generated randomly or based on a preselected algorithm.

In an embodiment, the first factorization is performed by: determining n1 as └sqrt(V)┘, determining n2 as ┌sqrt(V−(n1)\hat{ }2)┐, determining A′ as (n1+n2), and determining B′ as (n1−n2).

In an embodiment, A and B is each an integer value having a number of bits between 255 to 2\hat{ }13.

In an embodiment, the intervals comply with [s*P, t*P], the range CR is within the intervals, and s, t are integer values, and s and t are as small as possible, such that the range CR is partitioned into a plurality of intervals [j*P, (j+1)*P] for all integers j in s≤j≤(t−1).

In an embodiment, the intervals comply with the following conditions: determining a value q such that 2\hat{ }q is closest to the prime number P, where the range CR be part of the interval [s*2\hat{ }q, t*2\hat{ }q], where s, t, are integer values, and s, and t are as small as possible, such that the range CR is partitioned into a plurality of intervals [j*2\hat{ }q, (j+1)*2\hat{ }q] for all integers j in s≤j≤(t−1).

In an embodiment, the intervals comply with the following conditions: determining, by a sub-unit of the multiplier, a correction value X for each intermediate result, thereby building a group of correction values SCV, determining from a specification of the sub-unit a minimal value min(X) and a maximum value max(X) for which the sub-unit determines the correction value X, and such that range CR gets thus partitioned into a plurality of intervals of [min(X), max(X)].

In an embodiment, at least two of the intervals [min(x1), max(x1)] and [min(x2), max(x2)] overlap, and for such an interval pair, the subinterval is chosen such that it completely includes the intersection of the intervals [min(x1), max(x1)] and [min(x2), max(x2)].

In an embodiment, the selection of the two adjacent intervals includes a looping sub-method and a selection sub-method, where in each loop of the looping sub-method a pair of adjacent intervals is selected, and for that interval pair test operand data A″ and B″ are generated.

In an embodiment, the selection sub-method includes using a counter for each of the adjacent intervals, counting, using the counter, for an adjacent interval pair of intervals how often their sub-interval was hit by a test operand data pattern, and selecting, using the selection sub-method, a next interval pair based on the counter values, by selecting the next interval having the lowest counter value.

Alternatively or additionally, the method for test data generation increments the counters when their data patterns hit the corresponding sub-interval.

In an embodiment, the prime number P used for applied modular arithmetic is selected from the group consisting of NIST primes, Edwards primes, and generalized Mersenne primes.

According to another embodiment, a test data generation system generating test data for verifying a modular correction of a modular multiplication performed by a multiplier unit for very wide operands, where the multiplier unit performs a modular multiplication by performing a binary multiplication of two operands A, B and performing a coarse-grained modular correction such that an intermediate result is within a range CR much smaller than P2, where P is a prime number used as modulus for the modular multiplication, performing a fine-grained modular correction to the intermediate result achieving a result of the modular multiplication, where the result is within an interval of [0 to P), whereby different correction values are applied to different intervals of the intermediate result for the fine-grained correction, where the test data generation system includes a processor and a memory communicatively coupled to one or more processors, wherein said memory stores program code instructions that when executed, enable said one or more processor, to select two adjacent intervals of the intermediate result, define a sub-interval closely around a boundary between the selected adjacent intervals, select a value V in the sub-interval, use a first factorization algorithm for the value V for determining operands A′, B′, wherein the modular multiplication result R′ of the operands A′ and B′ corrected by the coarse-grained correction is in the sub-interval, repeatedly determine A′ plus varying ε-values as A″ values, and determine B″ values, so that the modular multiplication, corrected by the coarse-grained correction, is in the sub-interval, thereby generating the test operand data A″ and B″.

In an embodiment, the varying ε-values are generated randomly or based on a preselection.

In an embodiment, the first factorization is performed by determining n1 as └sqrt(V)┘, determining n2 as ┌sqrt(V−(n1)\hat{ }2)┘, determining A′ as (n1+n2), and determining B′ as (n1−n2).

In an embodiment, A and B are each an integer value having a number of bits between 255 to 2\hat{ }13.

In an embodiment, the intervals comply with [s*P, t*P], where the range CR is within the intervals, and s, t are integer values, and s and t are as small as possible, such that the range CR is partitioned into a plurality of intervals [j*P, (j+1)*P] for all integers j in s≤j≤(t−1).

In an embodiment, the intervals comply with the following conditions: determining a value q such that 2\hat{ }q is closest to the prime P, the range CR is part of the interval [s*2\hat{ }q, t*2\hat{ }q], where s, t, are integer values, and s, and t are as small as possible, such that the range CR is partitioned into a plurality of intervals [j*2\hat{ }q, (j+1)*2\hat{ }q] for all integers j in s≤j≤(t−1).

In an embodiment, the intervals comply with the following conditions: determining, by a sub-unit of the multiplier, a correction value X for each intermediate result, thereby building a group of correction values SCV, determining from a specification of the sub-unit a minimal value min(X) and a maximum value max(X) for which the sub-unit determines the correction value X, and such that range CR gets thus partitioned into a plurality of intervals of [min(X), max(X)].

In an embodiment, at least two of the intervals [min(x1), max(x1)] and [min(x2), max(x2)] overlap, and for such an interval pair, the subinterval is chosen such that it completely includes the intersection of the intervals [min(x1), max(x1)] and [min(x2), max(x2)].

In an embodiment, the selection of the two adjacent intervals includes a looping sub-method and a selection sub-method, where in each loop of the looping sub-method a pair of adjacent intervals is selected, and for that interval pair test operand data A″ and B″ are generated.

In an embodiment, the selection sub-method includes using a counter for each of the adjacent intervals, counting, using the counter, for an adjacent interval pair of intervals how often their sub-interval was hit by a test operand data pattern, and selecting, using the selection sub-method, a next interval pair based on the counter values, by selecting the next interval having the lowest counter value.

Alternatively or additionally, the method for test data generation increments the counters when their data patterns hit the corresponding sub-interval.

In an embodiment, the prime number P used for applied modular arithmetic is selected from NIST primes and Edwards primes and generalized Mersenne primes.

According to yet another embodiment, a computer program product for routing a service request to a service instance, where the multiplier unit performs a modular multiplication by performing a binary multiplication of two operands A, B and performing a coarse-grained modular correction such that an intermediate result is within a range CR much smaller than P\hat{ }2, wherein P is a prime number used as modulus for the modular multiplication, performing a fine-grained modular correction to the intermediate result achieving a result of the modular multiplication, wherein the result is within an interval of [0 to P), whereby different correction values are applied to different intervals of the intermediate result for the fine-grained correction, and where the computer program product includes a computer readable storage medium having program instructions embodied therewith, the program instructions being executable by one or more computing systems or controllers to cause the one or more computing systems to select two adjacent intervals of the intermediate result, and define a sub-interval closely around a boundary between the selected adjacent intervals, select a value V in the sub-interval, use a first factorization algorithm for the value V for determining operands A′, B′, where the modular multiplication result R′ of the operands A′ and B′ corrected by the coarse-grained correction is in the sub-interval, repeatedly determine A′ plus varying ε-values as A″ values, and determine B″ values so that the modular multiplication corrected by the coarse-grained correction is in the sub-interval, thereby generating the test operand data A″ and B″.

The descriptions of the various embodiments of the present invention have been presented for purposes of illustration, but are not intended to be exhaustive or limited to the embodiments disclosed. Many modifications and variations will be apparent to those of ordinary skills in the art without departing from the scope and spirit of the described embodiments. The terminology used herein was chosen to best explain the principles of the embodiments, the practical application or technical improvement over technologies found in the marketplace, or to enable others of ordinary skills in the art to understand the embodiments disclosed herein.

The present invention may be embodied as a system, a method, and/or a computer program product. The computer program product may include a computer readable storage medium(or media) having computer readable program instructions thereon for causing a processor to carry out aspects of the present invention.

The medium may be an electronic, magnetic, optical, electromagnetic, infrared or a semi-conductor system for a propagation medium. Examples of a computer-readable medium may include a semi-conductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD R/W), DVD and Blu-Ray-Disk.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disk read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the C programming language or similar programming languages. The computer readable program instructions may execute entirely on the user's computer, partly on the user's computer as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or another device to cause a series of operational steps to be performed on the computer, other programmable apparatus or other device to produce a computer implemented process, such that the instructions which execute on the computer, other programmable apparatuses, or another device implement the functions/acts specified in the flowchart and/or block diagram block or blocks.

The flowcharts and/or block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

The terminology used herein is for the purpose of describing particular embodiments only and is not intended to limit the invention. As used herein, the singular forms a, an and the are intended to include the plural forms as well, unless the context clearly indicates otherwise. It will further be understood that the terms comprises and/or comprising, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present invention has been presented for purposes of illustration and description, but is not intended to be exhaustive or limited to the invention in the form disclosed. Many modifications and variations will be apparent to those of ordinary skills in the art without departing from the scope and spirit of the invention. The embodiments are chosen and described in order to best explain the principles of the invention and the practical application, and to enable others of ordinary skills in the art to understand the invention for various embodiments with various modifications, as are suited to the particular use contemplated.

The inventive concept may be summarized by the following clauses:
1. A method for generating test data for verifying a modular correction of a modular multiplication performed by a multiplier unit for very wide operands,
wherein the multiplier unit performs a modular multiplication by
   performing a binary multiplication of two operands A, B and
   performing a coarse-grained modular correction such that an intermediate result is within a range CR much smaller than PA2, wherein P is a prime number used as modulus for the modular multiplication,
   performing a fine-grained modular correction to the intermediate result achieving a result of the modular multiplication, wherein the result is within an interval of [0 to P), whereby different correction values are applied to different intervals of the intermediate result for the fine-grained correction,
the method comprising:
selecting two adjacent intervals of the intermediate result, and
defining a sub-interval closely around a boundary between the selected adjacent intervals,
selecting a value V in the sub-interval,
using a first factorization algorithm for the value V for determining operands A′, B′, wherein the modular multiplication result R′ of the operands A′ and B′ corrected by the coarse-grained correction is in the sub-interval,
repeatedly determining A′ plus varying ε-values as A″ values, and
determining B″ values so that the modular multiplication corrected by the coarse-grained correction is in the sub-interval, thereby generating the test operand data A″ and B″.
2. The method according to clause 1, wherein the varying ε-values are generated randomly or based on a preselected algorithm.
3. The method according to clause 1 or 2, wherein the first factorization is performed by:
   determining n1 as └sqrt(V)┘,
   determining n2 as ┌sqrt(V−(n1)\hat{ }2)┐,
   determining A′ as (n1+n2), and
   determining B′ as (n1−n2).
4. The method according to any of the preceding clauses, wherein A and B is each an integer value having a number of bits between 255 to 2\hat{ }13.
5. The method according to any of the preceding clauses,
wherein the intervals comply with [s*P, t*P],
wherein the range CR is within the intervals, and
wherein s, t are integer values, and s and t are as small as possible,
such that the range CR is partitioned into a plurality of intervals [j*P, (j+1)*P] for all integers j in s≤j≤(t−1).
6. The method according to any of the preceding clauses, wherein the intervals comply with the following conditions:
determining a value q such that 2\hat{ }q is closest to the prime number P,
wherein the range CR be part of the interval [s*2\hat{ }q, t*2\hat{ }q], where s, t, are integer values, and s, and t are as small as possible,
such that the range CR is partitioned into a plurality of intervals [j*2\hat{ }q, (j+1)*2\hat{ }q] for all integers j in s≤j≤(t−1).
7. The method according to any of the preceding clauses, wherein the intervals comply with the following conditions:
determining, by a sub-unit of the multiplier, a correction value X for each intermediate result, thereby building a group of correction values SCV,
determining from a specification of the sub-unit a minimal value min(X) and a maximum value max(X) for which the sub-unit determines the correction value X, and
such that range CR gets thus partitioned into a plurality of intervals of [min(X), max(X)].
8. The method according to clause 7,
wherein at least two of the intervals 8 min(x1), max(x1)] and [min(x2), max(x2)] overlap, and wherein for such an interval pair, the subinterval is chosen such that it completely includes the intersection of the intervals [min(x1), max(x1)] and [min(x2), max(x2)].
9. The method according to any of the preceding clauses, wherein the selection of the two adjacent intervals comprises:
a looping sub-method and a selection sub-method, wherein in each loop of the looping sub-method a pair of adjacent intervals is selected, and for that interval pair test operand data A″ and B″ are generated.
10. The method of clause 9, wherein the selection sub-method comprises:
using a counter for each of the adjacent intervals,
counting, using the counter, for an adjacent interval pair of intervals how often their sub-interval was hit by a test operand data pattern, and
selecting, using the selection sub-method, a next interval pair based on the counter values, by selecting the next interval having the lowest counter value.
11. The method of clause 10, also using additionally an alternative method for test data generation, wherein also the alternative method increments the counters when their data patterns hit the corresponding sub-interval.
12. The method according to any of the preceding clauses, wherein the prime number P used for applied modular arithmetic is selected from NIST primes and Edwards primes and generalized Mersenne primes.
13. A test data generation system generating test data for verifying a modular correction of a modular multiplication performed by a multiplier unit for very wide operands,
wherein the multiplier unit performs a modular multiplication by:
   performing a binary multiplication of two operands A, B and
   performing a coarse-grained modular correction such that an
   intermediate result is within a range CR much smaller than P2, wherein P is a prime number used as modulus for the modular multiplication,
   performing a fine-grained modular correction to the intermediate result achieving a result of the modular multiplication, wherein the result is within an interval of [0 to P), whereby different correction values are applied to different intervals of the intermediate result for the fine-grained correction,
wherein the test data generation system comprises a processor and a memory communicatively coupled to one or more processors, wherein said memory stores program code instructions that when executed, enable said one or more processor, to:
select two adjacent intervals of the intermediate result,
define a sub-interval closely around a boundary between the selected adjacent intervals,
select a value V in the sub-interval,
use a first factorization algorithm for the value V for determining operands A′, B′, wherein the modular multiplication result R′ of the operands A′ and B′ corrected by the coarse-grained correction is in the sub-interval,
repeatedly determine A′ plus varying ε-values as A″ values, and
determine B″ values, so that the modular multiplication, corrected by the coarse-grained correction, is in the sub-interval, thereby generating the test operand data A″ and B″.
14. The system according to clause 13, wherein the varying ε-values are generated randomly or based on a preselection.
15. The system according to clause 13 or 14, wherein the first factorization is performed by:
   determining n1 as └sqrt(V)┘,
   determining n2 as ┌sqrt(V−(n1)\hat{ }2)┐,
   determining A′ as (n1+n2), and
   determining B′ as (n1−n2).
16. The system according to any of the clauses 13 to 15, wherein A and B are each an integer value having a number of bits between 255 to 2\hat{ }13.
17. The system according to any of the clauses 13 to 16,
wherein the intervals comply with [s*P, t*P],
wherein the range CR is within the intervals, and
wherein s, t are integer values, and s and t are as small as possible,
such that the range CR is partitioned into a plurality of intervals [j*P, (j+1)*P] for all integers j in s≤j≤(t−1).
18. The system according to any of the clauses 13 to 17, wherein the intervals comply with the following conditions:
determining a value q such that 2\hat{ }q is closest to the prime P,
wherein the range CR be part of the interval [s*2\hat{ }q, t*2\hat{ }q], where s, t, are integer values, and s, and t are as small as possible,
such that the range CR is partitioned into a plurality of intervals [j*2\hat{ }q, (j+1)*2\hat{ }q] for all integers j in s≤j≤(t−1).
19. The system according to any of the clauses 13 to 18, wherein the intervals comply with the following conditions:
   determining, by a sub-unit of the multiplier, a correction value X for each intermediate result, thereby building a group of correction values SCV,
   determining from a specification of the sub-unit a minimal value min (X) and a maximum value max (X) for which the sub-unit determines the correction value X, and
   such that range CR gets thus partitioned into a plurality of intervals of [min(X), max(X)].
20. The system according to any of the clauses 13 to 19,
wherein at least two of the intervals [min(x1), max(x1)] and [min(x2), max(x2)] overlap, and wherein for such an interval pair, the subinterval is chosen such that it completely includes the intersection of the intervals [min(x1), max(x1)] and [min(x2), max(x2)].
21. The system according to any of the clauses 13 to 20, wherein the selection of the two adjacent intervals comprises:
   a looping sub-method and a selection sub-method, wherein in each loop of the looping sub-method a pair of adjacent intervals is selected, and for that interval pair test operand data A″ and B″ are generated.
22. The system of clause 21, wherein the selection sub-method comprises:
   using a counter for each of the adjacent intervals,
   counting, using the counter, for an adjacent interval pair of intervals how often their sub-interval was hit by a test operand data pattern, and
   selecting, using the selection sub-method, a next interval pair based on the counter values, by selecting the next interval having the lowest counter value.
23. The system of clause 22, also using additionally an alternative method for test data generation, wherein also the alternative method increments the counters when their data patterns hit the corresponding sub-interval.
24. The system according to any of the clauses 13 to 23, wherein the prime number P used for applied modular arithmetic is selected from NIST primes and Edwards primes and generalized Mersenne primes.
25. A computer program product for routing a service request to a service instance, wherein the multiplier unit performs a modular multiplication by:
   performing a binary multiplication of two operands A, B and
   performing a coarse-grained modular correction such that an intermediate result is within a range CR much smaller than P\hat{ }2, wherein P is a prime number used as modulus for the modular multiplication,
   performing a fine-grained modular correction to the intermediate result
      achieving a result of the modular multiplication, wherein the result is within an interval of [0 to P), whereby different correction values are applied to different intervals of the intermediate result for the fine-grained correction,
and wherein the computer program product comprising a computer readable storage medium having program instructions embodied therewith, the program instructions being executable by one or more computing systems or controllers to cause the one or more computing systems to
select two adjacent intervals of the intermediate result, and
define a sub-interval closely around a boundary between the selected adjacent intervals,
select a value V in the sub-interval,
use a first factorization algorithm for the value V for determining operands A′, B′, wherein the modular multiplication result R′ of the operands A′ and B′ corrected by the coarse-grained correction is in the sub-interval,
repeatedly determine A′ plus varying ε-values as A″ values, and
determine B″ values so that the modular multiplication corrected by the coarse-grained correction is in the sub-interval, thereby generating the test operand data A″ and B″.

What is claimed is:

1. A computer-implemented method for generating test data for verifying a modular correction of a modular multiplication, the method comprising:
selecting, by the one or more processors, two adjacent intervals of an intermediate result obtained from a coarse-grained modular correction on a binary multiplication of two operands A, B and defining a sub-interval closely around a boundary between the selected adjacent intervals, wherein the intermediate result is within a range CR smaller than P\hat{ }2, with P being a prime number used as modulus for the modular multiplication;
selecting, by the one or more processors, a value V in the sub-interval;
using, by the one or more processors, a first factorization algorithm for the value V for determining operands A′, B′, wherein the modular multiplication result R′ of the operands A′ and B′ corrected by the coarse-grained correction is in the sub-interval;
repeatedly determining, by the one or more processors, A′ plus varying ε-values as A″ values; and
determining, by the one or more processors, B″ values so that the modular multiplication corrected by the coarse-grained correction is in the sub-interval, thereby generating a test operand data A″ and B″.

2. The method according to claim 1, wherein the varying ε-values are generated randomly or based on a preselected algorithm.

3. The method according to claim 1, wherein the first factorization is performed by:
determining, by the one or more processors, n1 as └sqrt(V)┘;
determining, by the one or more processors, n2 as ┌sqrt(V−(n2)\hat{ }2)┐;
determining, by the one or more processors, A′ as (n1+n2); and
determining, by the one or more processors, B′ as (n1=n2).

4. The method according to claim 1, wherein A and B is each an integer value having a number of bits between 255 to 2\hat{ }13.

5. The method according to claim 1, wherein the intervals comply with [s*P, t*P], a range CR is within the intervals, and wherein s, t are integer values, and s and t are as small as possible, such that the range CR is partitioned into a plurality of intervals [j*P, (j+1)*P] for all integers j in s≤j≤(t−1).

6. The method according to claim 1, wherein the intervals comply with at least one of:
determining, by the one or more processors, a value q such that 2\hat{ }q is closest to a prime number P, wherein the range CR is part of an interval [s*2\hat{ }q, t*2\hat{ }q], where s, t, are integer values, and s, and t are as small as possible, such that the range CR is partitioned into a plurality of intervals [j*2\hat{ }q, (j+1)*2\hat{ }q] for all integers j in s≤j≤(t−1).

7. The method according to claim 1, wherein the intervals comply with at least one of:
determining, by the one or more processors, using a sub-unit of the multiplier, a correction value X for each intermediate result, thereby building a group of correction values SCV; and
determining, by the one or more processors, from a specification of the sub-unit a minimal value min(X) and a maximum value max(X) for which the sub-unit determines a correction value X, such that the range CR gets thus partitioned into a plurality of intervals of [min(X), max(X)].

8. The method according to claim 7, wherein at least two of the intervals [min(x1), max(xl)] and [min(x2), max(x2)] overlap, and wherein for such an interval pair, a subinterval is chosen such that it completely includes an intersection of the intervals [min(x1), max(x1)] and [min(x2), max(x2)].

9. The method according to claim 1, wherein a selection of two adjacent intervals comprises a looping sub-method and a selection sub-method, wherein in each loop of the looping sub-method a pair of adjacent intervals is selected, and for that interval pair test operand data A″ and B″ are generated.

10. The method according to claim 9, wherein the selection sub-method comprises:
using, by the one or more processors, a counter for each of the adjacent intervals;
counting, by the one or more processors, using the counter, for an adjacent interval pair of intervals how often their sub-interval was hit by a test operand data pattern; and
selecting, by the one or more processors, using the selection sub-method, a next interval pair based on counter values, by selecting a next interval having a lowest counter value.

11. The method of claim 10, further comprising:
incrementing, by the one or more processors, the counters when their data patterns hit a corresponding sub-interval.

12. The method according to claim 1, wherein a prime number P used for applied modular arithmetic is selected from at least one of NIST primes, Edwards primes, and generalized Mersenne primes.

13. A computer system for generating test data for verifying a modular correction of a modular multiplication, comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
selecting, by the one or more processors, two adjacent intervals of an intermediate result obtained from a coarse-grained modular correction on a binary multiplication of two operands A, B and defining a sub-interval closely around a boundary between the selected adjacent intervals, wherein the intermediate result is within a range CR smaller than P\hat{ }2, with P being a prime number used as modulus for the modular multiplication;
selecting, by the one or more processors, a value V in the sub-interval;
using, by the one or more processors, a first factorization algorithm for the value V for determining operands A′, B′, wherein the modular multiplication result R′ of the operands A′ and B′ corrected by the coarse-grained correction is in the sub-interval;
repeatedly determining, by the one or more processors, A′ plus varying ε-values as A″ values; and
determining, by the one or more processors, B″ values so that the modular multiplication corrected by the coarse-grained correction is in the sub-interval, thereby generating a test operand data A″ and B″.

14. The computer system according to claim 13, wherein the varying ε-values are generated randomly or based on a preselected algorithm.

15. The computer system according to claim 13, wherein the first factorization is performed by:
determining, by the one or more processors, n1 as └sqrt(V)┘;
determining, by the one or more processors, n2 as ┌sqrt(V−(n1)\hat{ }2)┐;
determining, by the one or more processors, A′ as (n1+n2); and
determining, by the one or more processors, B′ as (n1−n2).

16. The computer system according to claim 13, wherein A and B is each an integer value having a number of bits between 255 to 2\hat{ }13.

17. The computer system according to claim 13, wherein the intervals comply with [s*P, t*P], a range CR is within the intervals, and wherein s, t are integer values, and s and t are as small as possible, such that the range CR is partitioned into a plurality of intervals [j*P, (j+1)*P] for all integers j in s≤j≤(t−1).

18. The computer system according to claim 13, wherein the intervals comply with at least one of:
determining, by the one or more processors, a value q such that 2\hat{ }q is closest to a prime number P, wherein the range CR be part of an interval [s*2\hat{ }q, t*2\hat{ }q], where s, t, are integer values, and s, and t are as small as possible, such that the range CR is partitioned into a plurality of intervals [j*2\hat{ }q, (j+1)*2\hat{ }q] for all integers j in s≤j≤(t−1).

19. The computer system according to claim 13, wherein the intervals comply with at least one of:
determining, by the one or more processors, using a sub-unit of a multiplier, a correction value X for each intermediate result, thereby building a group of correction values SCV; and
determining, by the one or more processors, from a specification of the sub-unit a minimal value min(X) and a maximum value max(X) for which the sub-unit determines a correction value X, such that range CR gets thus partitioned into a plurality of intervals of [min(X), max(X)].

20. The computer system according to claim 19, wherein at least two of the intervals [min(x1), max(x1)] and [min(x2), max(x2)] overlap, and wherein for such an interval pair, the subinterval is chosen such that it completely includes an intersection of the intervals [min(x1), max(x1)] and [min(x2), max(x2)].

21. The computer system according to claim 13, wherein a selection of two adjacent intervals comprises a looping sub-method and a selection sub-method, wherein in each loop of the looping sub-method a pair of adjacent intervals is selected, and for that interval pair test operand data A″ and B″ are generated.

22. The computer system according to claim 21, wherein the selection sub-method comprises:
using, by the one or more processors, a counter for each of the adjacent intervals;
counting, by the one or more processors, using the counter, for an adjacent interval pair of intervals how often their sub-interval was hit by a test operand data pattern; and
selecting, by the one or more processors, using the selection sub-method, a next interval pair based on counter values, by selecting a next interval having a lowest counter value.

23. The computer system according to claim 22, further comprising:
incrementing, by the one or more processors, the counters when their data patterns hit a corresponding sub-interval.

24. The computer system according to claim 13, wherein a prime number P used for applied modular arithmetic is selected from at least one of NIST primes, Edwards primes, and generalized Mersenne primes.

25. A computer program product for generating test data for verifying a modular correction of a modular multiplication, comprising:
one or more computer readable storage media, and program instructions collectively stored on the one or more computer readable storage media, the program instructions comprising:
program instructions to select, by the one or more processors, two adjacent intervals of an intermediate result obtained from a coarse-grained modular correction on a binary multiplication of two operands A, B and defining a sub-interval closely around a boundary between the selected adjacent intervals, wherein the intermediate result is within a range CR smaller than P\hat{ }2, with P being a prime number used as modulus for the modular multiplication;
program instructions to select, by the one or more processors, a value V in the sub-interval;
program instructions to use, by the one or more processors, a first factorization algorithm for the value V for determining operands A′, B′, wherein the modular multiplication result R′ of the operands A′ and B′ corrected by the coarse-grained correction is in the sub-interval;
program instructions to repeatedly determine, by the one or more processors, A′ plus varying ε-values as A″ values; and
program instructions to determine, by the one or more processors, B″ values so that the modular multiplication corrected by the coarse-grained correction is in the sub-interval, thereby generating a test operand data A″ and B″.
